(19) United States
(12) Patent Application Publication
(10) Pub. No.: US 2006/0112620 A1
(43) Pub. Date: Jun. 1, 2006

(54) Plant growth stimulator and method related thereto

(76) Inventor: Roger Lee Rapp, Lanexa, VA (US)

Correspondence Address: Andrew J. Befumo, 6237 Tidewater Trail, Church View, VA, 23032, US

(21) Appl. No.: 10/990,810

(22) Filed: Nov. 17, 2004

(51) Int. Cl. A01G 13/02

(52) U.S. Cl. 47/29.6

(57) ABSTRACT

An artificial plant designed to be placed adjacent to landscaping plants. The artificial plant partially shades the landscaping plants, forcing them to compete for light. The artificial plant is adjustable in height and may comprise a watering and feeding device and light filtering shades to only allow specific spectra of light to contact the landscaping plant being shaded.

### FIELD OF THE INVENTION

The present invention relates to a device and method to stimulate plant growth. In particular, the present invention is directed towards an aesthetically pleasing artificial plant which stimulates and directs the growth of nearby plants by forcing them to compete for existing light.

### BACKGROUND OF THE INVENTION

The survival rate of a transplanted tree or shrub generally decreases as the size of the transplanted tree or shrub increases. This is because the larger a tree or shrub the more likely it is to suffer root damage during transplantation. Accordingly, landscapers typically use relatively small trees, and new landscaping schemes which encompass trees and shrubs typically take several years to mature and become aesthetically pleasing.

It has been well documented that the amount and type of available light affects the rate and direction of plant growth. For example, U.S. Pat. No. 6,052,941 to Deichman teaches that providing a solar corridor between crop rows improves crop yields by enabling continued and greater contribution to the photosynthetic activity of lower plant structures. While the Deichman model works well for agricultural crops where maximum fruit or seed production per planted acre can be accomplished by increasing light availability to the entire plant, the model does not work well for certain aesthetic outdoor plant applications. In aesthetic landscaping applications it is more desirable to force a plant to grow in a particular direction by completely shading sections of the plant where growth is not desired, while providing light to sections of the plant where growth is desired. In many instances the light provided should be scattered in a pattern which replicates light rays shining through leaves of a plant canopy. This method forces the plants beneath the canopy to compete for the light provided, and rapidly grow in the desired direction.

While light is critical for plant growth, it has been demonstrated that too much light, and certain light spectra can be harmful to plants. Many prior art devices have thus been directed toward protecting young outdoor plants from damaging solar radiation. U.S. Pat. No. 5,090,155 to Rodgers teaches a seedling support which utilizes a tube of photodegradable polyolefin or similar type material with a stake attached thereto to hold the tube upright. The polyolefin is chosen such that it has a particular shade factor so that, when it is positioned about a seedling, a predetermined percentage of damaging solar radiation is prohibited from reaching the seedling. U.S. Pat. No. 5,022,181 to Longstaff teaches a light filter which blocks green, yellow and infa-red light, while permitting photosynthesis to occur with blue light. However, none of these prior art devices teach a method of directing plant growth. Furthermore, light filter shades such as that described in the Rodgers' patent are not aesthetically pleasing and are therefore not desirable for landscaping applications.

Another problem associated with transplantation of trees and large shrubs is water and nutrient availability. Because the root structure of a tree or large shrub is likely to be damaged during transplantation, increased amounts of water and nutrients need to be supplied in order to support above ground structures. This phenomenon renders newly transplanted trees and shrubs particularly susceptible to desiccation. A typical method of addressing the problem of water availability is demonstrated in U.S. Pat. No. 6,108,970 to Ball. Ball teaches a self-watering plant guard in which a tubular body is provided with a means to allow water to drip into the root zone of the plant. However, drip type irrigation encourages upward root growth, while it is more desirable to encourage downward root growth in trees and large shrubs. When downward root growth is encouraged, the transplanted tree or large shrub is more quickly able to find the water it needs from natural sources. Downward root growth also better anchors the developing tree or large shrub in the ground.

The prior art also does nothing to fill gaps in new landscaping while newly transplanted trees and shrubs mature. It is therefore an object of the present invention to provide a plant growth stimulator which is aestetically pleasing and fills gaps in new landscaping while trees and shrubs mature.

Another object of the present invention is to provide a plant growth stimulator which selectively shades areas of a plant.

Another object of the present invention is to provide a plant growth stimulator which is adjustable for use on plants of different sizes and shapes

Another object of the present invention is to provide a plant growth stimulator which provides light of a selected spectrum to a selected section of a plant.

Another object of the present invention is to provide a plant growth stimulator which guards against plant dessication.

Another object of the present invention is to provide a plant growth stimulator which provides a means for delivering nutrition to a plant.

Another object of the present invention is to provide a plant growth stimulator which encourages downward root growth.

Another object of the present invention is to provide a plant growth stimulator which causes a tree or shrub to grow taller and faster than otherwise possible.

### SUMMARY OF THE INVENTION

The present invention is directed towards a shading device to aid in plant growth. The shading device is constructed to resemble a plant, and comprises at least one anchor for maintaining the shading device in an active location, at least one shade support fixedly attached to the anchor and extending outwardly therefrom, and at least one shading means for stimulating and directing plant growth. The shading means attaches to and extends outwardly from the shade support. The shading means provides a scattered pattern of shading and a scattered pattern of light penetration to an area below the shading means.

In a preferred embodiment of the shading device, the anchor comprises a substantially flat base, and a plurality of tines fixedly attached to and extending downwardly from the substantially flat base. A reservoir disposed within the substantially flat base has a reservoir opening, a reservoir cap sealing the reservoir opening, and one or more feed openings disposed in the tines. The feed openings are in fluid communication with an area of ground in proximity to a plant. At least one telescopically adjustable shade support is fixedly attached to the anchor and extends outwardly therefrom. The shade support comprises a plurality of locking telescopic sections which may be locked in any position between a fully retracted position and a fully extended position. At least one shading means is attached to and extends outwardly from the shade support. The shading means stimulates and directs plant growth by providing a scattered pattern of shading and a scattered pattern of light penetration to an area below the shading means. The shading means is adaptable to allow a selected spectrum of light penetration.

The present invention is also directed towards a method for stimulating and directing plant growth. The method comprises providing the shading device of the present invention and situating the shading device in proximity to a plant such that available light is filtered through the shading device before contacting the plant.

### BRIEF DESCRIPTION OF THE DRAWINGS

The accompanying drawings illustrate a complete embodiment of the invention according to the best modes so far devised for the practical application of the principles thereof, and in which:

FIG. 1 depicts the Plant Growth Stimulator of the present invention.

FIG. 2 depicts a preferred embodiment of the Plant Growth Stimulator of the present invention.

FIG. 2(a) depicts a detail of a preferred embodiment of the Plant Growth Stimulator of the present invention.

FIG. 2(b) depicts a detail of a preferred embodiment of the Plant Growth Stimulator of the present invention.

FIG. 2(c) depicts a detail of a preferred embodiment of the Plant Growth Stimulator of the present invention.

### DETAILED DESCRIPTION OF THE PREFERRED EMBODIMENTS

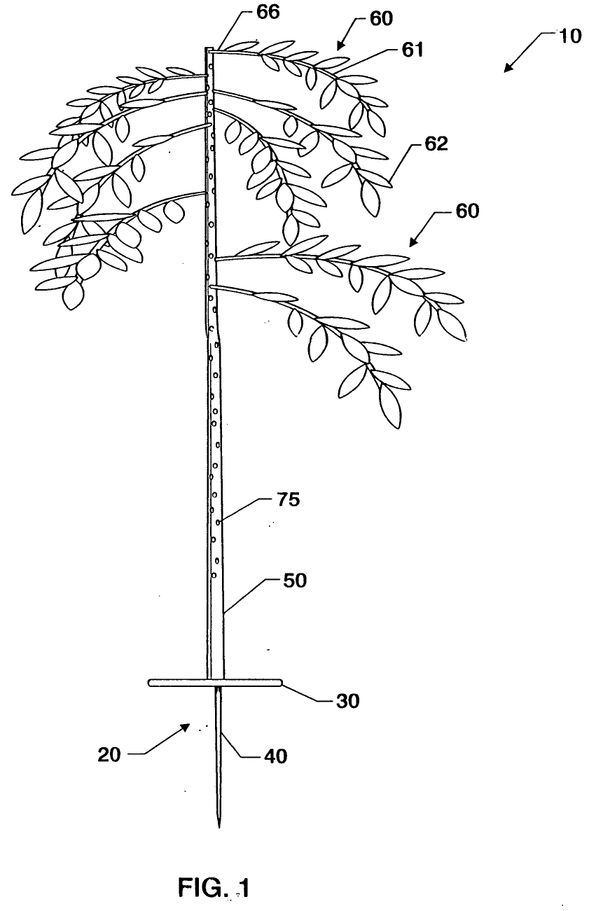

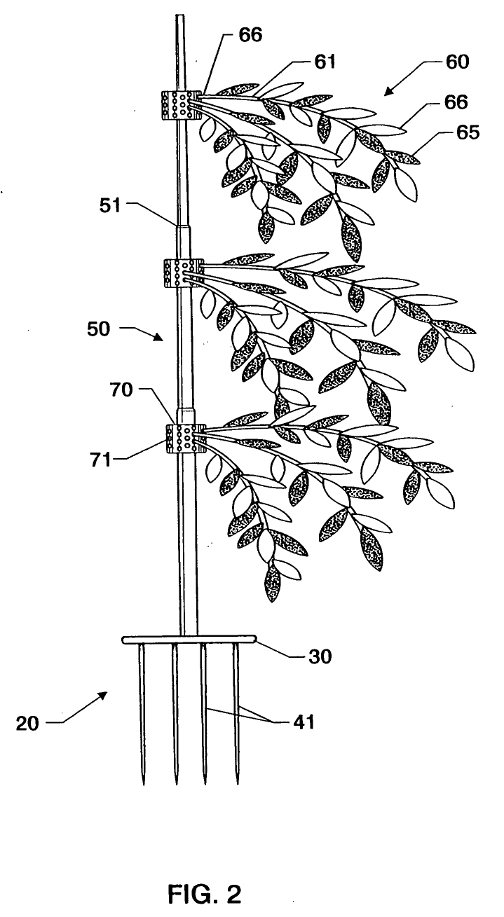

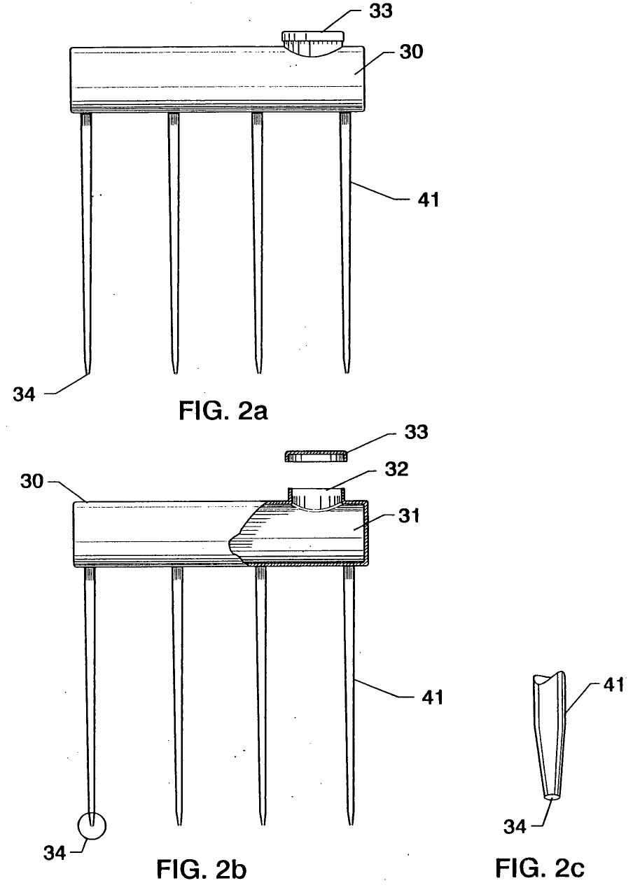

Referring now to the drawings where similar elements are numbered the same, FIG. 1 depicts the plant growth stimulator 10 of the present invention. The invention is constructed to look like a plant, and comprises at least one anchor 20 for maintaining the shading device in an active location. An active location is any location proximate to a plant, whereby the plant growth stimulator selectively blocks or filters available light before the light contacts the plant. The active location is preferably outdoors. In a preferred embodiment of the invention the anchor 20 is a substantially flat base 30 with at least one downwardly facing tine 40. In an alternate embodiment of the invention the anchor 20 is a downward extension of a shade support 50. In a most preferred embodiment of the invention as shown in FIG. 2, the anchor 20 comprises a plurality of tines 41 fixedly attached to and extending downwardly from the substantially flat base 30. As seen in FIGS. 2(a), 2(b), and 2(c), the substantially flat base 30 comprises a reservoir 31 disposed therein. A reservoir opening 32 is sealed with a removable reservoir cap 33. One or more feed openings 34 disposed in the tines 41 are in fluid communication with the reservoir 31. The feed openings 34 provide a draining means for communicating fluid from within the reservoir 31 to an area of ground surrounding the tines 41. When using the invention the reservoir 31 is filled with a liquid which is preferably water or a plant food solution. The liquid drains through the feed openings 34 to keep adjacent plants (not pictured) fed and watered. The reservoir 31 preferably holds enough liquid to last about a week.

Referring back to FIG. 1, at least one shade support 50 is fixedly attached to, and extends outwardly from the anchor 20. The shade support 50 preferably extends upwardly from the anchor 20. In a preferred embodiment of the invention the shade support 50 is adjustable in length. Any means of adjustability known to those of average skill in the art may be used. In a most preferred embodiment of the invention as shown in FIG. 2, the shade support 50 is a telescopic tube 51. The telescopic tube 51 includes locking mechanisms (not shown), which may be any locking mechanisms known to those of average skill in the art. The locking mechanisms (not shown) secure the telescopic tube 51 in any position between a fully retracted position and a fully extended position.

Referring back to FIG. 1, at least one shading means 60 is attached to and extends outwardly from the shade support 50. The shading means 60 filters light passing therethrough so that a plant located proximate to the invention receives a scattered pattern of shading and a scattered pattern of light. In one embodiment of the invention, a scattered pattern of light which contains the full spectrum of available light penetrates the shading means 60. In a preferred embodiment of the invention only a select spectrum of light penetrates the shading means 60. In another preferred embodiment of the invention the shading means 60 comprises a plurality of artificial leaves 62. The artificial leaves 62 are constructed of material that either completely blocks light, or a material which allows a particular spectrum of light to pass through. In a preferred embodiment of the invention as shown in FIG. 2, the shading means 60 comprises both light blocking leaves 65 and light filtering leaves 66. This allows the user to fully shade certain sections of the plant, while directing only light beneficial to plant growth to select sections of the plant. The light filtering leaves 66 preferably block green, yellow and infa-red light, while permitting blue light to pass through. In another preferred embodiment of the invention the shading means 60 is mountable at various locations along the shade support 50. The shading means 60 is preferably placed so that the plant being shaded competes for light with the shading device 10. Referring to FIG. 1, the shading means 60 is constructed of wire 61 with the artificial leaves 62 attached thereto. A first end 66 of the wire 61 is then inserted into one of a plurality holes 75 disposed in the shade support 50. In another preferred embodiment of the invention as shown in FIG. 2, the first ends 66 of the wires 61 of plurality of shading means 60 mount into holes 71 disposed in movable collars 70. The movable collars 70 mount at any location along the shade support 50. Many other means for constructing and mounting shading means exist in the art, and it is not intended that this invention be limited to any particular one.

The invention is also directed towards a method for stimulating plant growth. The method comprises situating the shading device 10 (FIG. 1) of the present invention in proximity to one or more plants (not shown) so that available light is filtered through the shading device 10 before contacting the plant (not shown). Tines 41 (FIG. 2) on the anchor 20 are then inserted into the ground to stabilize the shading device 10. With the shading device 10 in place, the reservoir cap 33 (FIGS. 2(a), 2(b)) is removed, the reservoir 31 is filled with liquid and the reservoir cap 33 is replaced. The liquid may be water, and is preferably a liquid plant food solution. Referring to FIG. 1, the position of the shading means 60 is adjusted to provide a scattered pattern of light to only the sections of the plant where growth is desired. The height of the device is adjustable, as is the placement of the shading means 60. The adjustability allows a user to adjust the device to shade plants of various sizes. Another advantage of adjustability is that the device is adaptable to compliment a wide variety of landscaping themes.

The above description and drawings are only illustrative of preferred embodiments which achieve the objects, features and advantages of the present invention, and it is not intended that the present invention be limited thereto. Any modification of the present invention which comes within the spirit and scope of the following claims is considered part of the present invention.

What is claimed is:

1. A shading device to aid in plant growth, the device comprising:
at least one anchor for maintaining the shading device in an active location, at least one shade support fixedly attached to the anchor and extending outwardly therefrom, and at least one shading means for stimulating and directing plant growth, the shading means attached to and extending outwardly from the shade support, whereby the shading means provides a scattered pattern of shading and a scattered pattern of light penetration to an area below the shading means, whereby the shading device is constructed to resemble a plant.

2. A shading device according to claim 1, wherein the shade support extends substantially vertically from the anchor.

3. A shading device according to claim 1, wherein the shade support is adjustable in length.

4. A shading device according to claim 1, wherein the shading means mounts to the shade support with a movable mount, whereby the shading means may be fixed at any one of a plurality of locations along the shade support.

5. A shading device according to claim 4, wherein the movable mount comprises movable collars.

6. A shading device according to claim 5 wherein the movable collars comprise a plurality of holes disposed therein.

7. A shading device according to claim 1, wherein the shading means comprises a plurality of artificial leaves.

8. A shading device according to claim 7, wherein the shading means further comprises a wire support onto which the leaves attach.

9. A shading device according to claim 1, wherein the shading means is constructed from a material from the group consisting of plastic, vinyl, nylon, PVC, woven fabric and fabric sheets.

10. A shading means according to claim 1, wherein the shading means comprises light filtering material.

11. A shading device according to claim 1, wherein the shading means provides a scattered pattern of a full spectrum of available light to the area below the shading means.

12. A shading device according to claim 1, wherein the shading means provides a scattered pattern of a select spectrum of available light to the area below the shading means.

13. A shading device according to claim 1, wherein blue light penetrates the shading means in a scattered pattern and wherein green, yellow and infa-red light are completely blocked by the shading means.

14. A shading device according to claim 1, wherein the anchor comprises a plurality of downward-facing tines.

15. A shading device according to claim 1, wherein the anchor comprises a substantially flat base.

16. A shading device according to claim 1, wherein the anchor is a downward extension of the shade support.

17. A shading device according to claim 3, wherein the shade support is a telescopic tube, wherein the telescopic tube comprises a plurality of locking telescopic sections whereby the telescopic tube may be locked in any position between a fully retracted position and a fully extended position.

18. A shading device according to claim 15, wherein the anchor further comprises a plurality of tines fixedly attached to and extending downwardly from the substantially flat base.

19. A shading device according to claim 18, wherein the substantially flat base comprises a reservoir, wherein the reservoir is disposed within the substantially flat base; and
wherein a reservoir opening disposed in an outer wall of the reservoir is sealed with a reservoir cap; and
wherein one or more feed openings disposed in the tines are in fluid communication with the reservoir, whereby the feed openings provide a draining means for communicating fluid from within the reservoir to an area surrounding the tines.

20. A shading device to aid in plant growth, the device comprising:
at least one anchor for maintaining the shading device in an active location, wherein the anchor comprises a substantially flat base, a plurality of tines fixedly attached to and extending downwardly from the substantially flat base, a reservoir disposed within the substantially flat base, a reservoir opening disposed in an outer wall of the substantially flat base, a reservoir cap sealing the reservoir opening, and one or more feed openings disposed in the tines, the feed openings being in fluid communication with the reservoir, the feed openings further being in fluid communication with an area of ground in proximity to a plant; and
at least one telescopically adjustable shade support fixedly attached to the anchor and extending outwardly therefrom, the shade support comprising a plurality of locking telescopic sections whereby the shade support may be locked in any position between a fully retracted position and a fully extended position; and
at least one shading means for stimulating and directing plant growth, the shading means attached to and extending outwardly from the shade support, whereby the shading means comprises a plurality artificial plant leaves fixedly attached to a wire, whereby the shading means provides a scattered pattern of shading and a scattered pattern of light penetration to an area below the shading means and whereby the shading means is adaptable to provide a selected spectrum of available light to the area below the shading means; and
whereby the shading device is constructed to resemble a plant.

21. A method for stimulating and directing plant growth, the method comprising;
providing the shading device of the present invention, situating the shading device in proximity to a plant whereby available light is filtered through the shading device before contacting the plant, inserting the tines into the ground, removing the reservoir cap, filling the reservoir with a fluid, and replacing the reservoir cap.

22. A method according to claim 21, further comprising adjusting the shading means to provide a scattered pattern of shading and a scattered pattern of light penetration to an area below the shading means.

23. A method according to claim 21 wherein the fluid is water.

24. A method according to claim 21 wherein the fluid is a liquid plant food solution.
